(19) United States
(12) Patent Application Publication
(10) Pub. No.: US 2005/0123657 A1
(43) Pub. Date: Jun. 9, 2005

(54) Process for assembly and installation of a snack package adapted for attachment to a beverage container thereby allowing the combination to take up the same shelf space as the container alone for vending and off-the-shelf sales with augmented marketing adaptation

(76) Inventor: Mark James Beckman, Los Angeles, CA (US)

Correspondence Address: JOHN E. HALAMKA, PALOS VERDES ESTATES, P.O. BOX 207, LOS ANGELES, CA, 90274, US

(21) Appl. No.: 10/728,447

(22) Filed: Dec. 4, 2003

(51) Int. Cl. A23B 4/00

(52) U.S. Cl. 426/112

(57) ABSTRACT

A process to assemble an arrangement of a snack and a beverage container, along with promotional material, all mountable into a standard vending machine slot (use language of claim) within the product storage area previously occupied by a beverage container or a snack alone performed during the normal replenishment maintenance of the vending machine product storage area or off-the shelf also occuping the same space as a beverage container alone. Said assembly consisting of placing a snack product prepackaged to surround the top of a beverage container, engaging a retaining device capable of holding the snack in place during the dispensing of the combination yet allowing easy disassembly of the combination by the consumer after retrieval of the combination from the external area of a vending machine after the combination has been released from the product storage area upon payment of sufficient currency and selection of the product or purchased off-the shelf. The retaining device of a disk and bottle cap attachment may be replaced with a containment cage surrounding the snack and beverage container. Preselected promotional material may be printed on the retaining device disk as well as on the containment cage. The top of the containment cage may contain additional promotional material in the form of a mini-CD disk containing software, audio program, or a video program.

### BACKGROUND OF THE INVENTION

1. Field of the Invention

This invention relates to the art of assembling and dispensing a combination of a snack and a beverage utilizing the standard rack space in a vending machine heretofore utilized to dispense only a beverage from the single shelf space or utilizing one compartment in a product storage area of a vending machine that is preferably refrigerated, and more particularly providing the quick assembly of the combination of a snack and beverage, loading the combination into the vending machine and setting of a price point all based upon the past history of sales experienced for the location of the vending machine. Further, the device used to attach the snack to the container may contain promotional material to further entice the customer to purchase the products. The process, as practiced according to the teaching of this invention, allows the combination of the product mix, of snack and drink, (and promotional material) to be preselected and said mix easily adjusted to maximize sales at the site of the vending machine. The retrofitting of a typical vending machine is unnecessary thereby providing the marketing advantage of presenting a product mix to match the current variation with the point of sale history for the location of the vending machine, or demographic information, if no sales history exists. Additionally, if the previous configured bundled combination fails to attract or entice the consumer to make a purchase, the snack portion and attachment deice may be removed and recombined to an alternative beverage, better suited to compliment the snack offering. This flexibility provides a marketing advantage over fixed inventory mix of a beverage or a snack alone that previously was dependent upon the load of materials brought by the vending machine maintenance person to the site of the vending machine, usually remote from the supply source.

Further, the process of assembly of a snack and beverage, with optional promotional material, to take up the same space as a single beverage or snack alone may also be utilized to sell the combination off-the-shelf. This process may be utilized in over the counter situations such as a combination of an alcoholic beverage such as beer and nuts at a sports game.

2. Description of the Prior Art

The art of vending has a long history and many variations. The point of sale vending art has evolved from a simple insulated ice box in a county store subject to established business hours to the modern stand alone self-refrigerated machines usually positioned outside of a business to be accessible 24/7. The interior structure and working mechanisms in the ice box or modern vending machine has also evolved to accommodate each device, each change in technology and the demands of the consumer for ease of access, ease of use, reliability in dispensing the desired product and provision of a variety of product mix to meet the changing preferences for products.

The teaching herein utilizes the existing space provided in a vending machine to dispense a combination of a snack and a beverage without requiring the mechanical retrofitting of the vending machine or preexisting individual shelf space or product storage rack compartment space within a vending machine. Consideration is given to the condition that the vending machine is programmable to adjustably assign a price to each individual storage rack space. The device used to retain the snack and the beverage as a unit may contain preselected promotional material to further entice a customer to make a purchase from the vending machine.

In addition, the teaching according to this invention may be utilized in those vending machines previously configured to dispense only a snack. Some configurations of machines may accommodate the combination of snack and beverage taught herein especially if the snack vending machine was used to dispense snacks that required refrigeration.

Flexibility in the market place is required to provide a profit margin in the highly competitive and changing product environment of the vending machine business or over the counter sales.

Currently there are over three global non-alcoholic beverage companies and several beer companies each with a large number of standard products as well as additional products that change in an effort to capture market share. Additionally, there are also several global snack food manufacturers that face similar challenges in the marketplace.

Each time the businessperson wishes to add a product to a vending machine, the existing mix must be evaluated to utilize the existing rack space in the most efficient manner to maximize the profit margin for the location. The same criteria concern the over the counter sale.

This ongoing estimation of the marketability of the products requires a period of guessing the mix of products to load onto the vending machine maintenance vehicle that travels to the vending machine locations to service and refill a number of vending machines remote from the warehouse or other source of the supply of product. If the guess is incorrect the maintenance vehicle may come back with a partial load wasting time and fuel to haul the excess product. The flexibility of adjustment of the product mix using the teaching of this invention minimizes the return of product after completion of the maintenance route. The minimizing of unused product is particularly desirable because of the costs associated with returns due to spoilage/lost sales and additional labor.

Implementing the flexibility of matching a particular snack food with a particular beverage at the point of maintenance of the vending machine as taught by this invention provides a method to increase the profitability of existing vending machines. By increasing the efficiency in use of existing shelf space, intended to maximize the sales dollars for that space, the total dollar inventory could be substantially increased compared to current inventory levels with the added utilization of incremental products, combination packaging. The value to the buyer by assembling a combination of a snack food with a beverage (and possibly promotional material) supports the success of vending convenience.

Similarly, the convenience of handling one item as a single priced combination such as a bag of nuts and a container of beer with promotional material for high volume over-the-counter sales reduces shelf space and increases efficiency.

Prior solutions to the ability to supply a snack and beverage at a vending location have taught the use of multiple vending machines at each location, some machines specializing in handling the unique snack configuration and environment required to preserve the freshness of the snack, other machines at the location specializing in handling beverages. Some vending locations would require extensive modification to accommodate this multiple vending machine solution and additional overhead for space and electrical power connection. This method may seriously reduce the existing profit margin with the increased cost of space and support expenses.

A proposed solution to the problem is attempted in U.S. Pat. No. 5,445,287 ('287). This solution teaches the use of an existing vending machine for co-dispensing a snack food and a beverage however; the snack food must be repackaged into a container that occupies the space of a beverage requiring the elimination of the beverage from that shelf space. '287 further teaches the use of multiple transactions to obtain the beverage and then the snack desired by the consumer.

Maintaining the product storage according to the teaching of '287 with the proper mix of product requires extensive trial and error on the part of the vending machine maintenance person to guess at the proper mix of beverage and snack products.

If the product storage area is filled with the combination assembled according to the teaching of this invention, the prospective consumer may find at least the snack or beverage to be acceptable and the attached product acceptable. Therefore, the consumer will be more likely to make a purchase from the vending machine maintained according to the teaching of the present invention rather than finding a '287 vending machine empty of the consumer preferred product.

'278 does not teach or suggest that the snack and beverage may be adapted to occupy only one space in the rack as a beverage alone. Conceivably with '287 , a customer might purchase a snack can alone, instead of purchasing both a snack and a beverage. This type of sale represents a substitution of items sold. The present invention teaches that should a customer desire to purchase a snack or promotional item, they must purchase the snack as a part of a combination package, which therefore represents an incremental sale, not a substitute sale. Thus, there has long been a need for an arrangement which allows the maintenance of vending machines to easily utilize the existing space to dispense a combination of snack and beverage coupled with ease of combining a snack and beverage at the point of maintenance of the vending machine to adapt to the customer preferences using that particular vending machine.

It is desired that the arrangement allow a full range of combination of a beverage and snack with the possible addition of promotional material to accommodate the consumer's rapid change in preferences.

It is further desired that the assembly of the combination of snack and beverage require very little adjustment to the maintenance routine previously required for only a beverage vending or a snack vending capability.

It is further desired that the arrangement be adaptable to vending machines presently capable of vending a beverage alone as well as those vending machines capable of vending a snack alone if the particular snack machine can accommodate the combination without modification and especially if the machine has the capability of refrigeration of the combination.

It is further desired that the assembly of the beverage and snack be able to be activated by the maintenance person and deactivated by a consumer without compromising the product quality and eye appeal. It is preferred that the engagement or disengagement be accomplished, without requiring great strength. It is desired that this be one easy movement yet be securely engaged so as to not inadvertently disengage the snack from the beverage.

It is further desired that the arrangement engagement not be adversely affected during negotiating the dispensing pathway including the final retrieval of the combination from the bottom of the dispensing chute by the consumer.

It is further desired that the engagement/disengagement not require strong pressure that would crush the snack or compromise the beverage container.

It is desired that a simple latching or unlatching movement engage and disengage the arrangement holding the snack to the beverage.

It is desired that this movement be accomplished with the placement of a simple, space efficient device that can be engaged even if the user does not have dry hands or does have weak hand strength.

It is further desired that no special tool be required to activate the engagement of the beverage and snack combination and nothing but normal hand pressure be required to disengage the snack from the beverage.

It is desired that if the promotional material is integrated within the attachment arrangement that the promotional material not be degraded by the assembly and disassembly of the beverage and snack combination.

### SUMMARY OF THE INVENTION

Accordingly, it is an object of the present invention to provide a process to produce an augmented product responsive to changing customer preferences thereby providing marketing enhancement to existing vending machines capable of dispensing a beverage alone or a snack alone if it is configured to accommodate the combination without modification and particularly if the machine includes refrigeration. The vending machine should have the capability of adjusting the price point for the vended products in at least a column of product with the preferred arrangement of setting the price point for each individual storage unit.

It is an object of the present invention to provide an improved arrangement that allows the maintenance person of a vending machine to refill the racks within the product storage area of the machine with a preselected combination of a beverage and a snack with the possibility of using promotional material as part of the arrangement all insertable in the same rack space previously occupied by a beverage alone or a snack alone without reconfiguring the rack thereby enhancing the consumer attraction to the vending machine and increasing the income derived from the vending machine.

It is another object of the present invention to provide a method to easily attach the snack to the beverage. This assembly may be performed at the beverage manufacturer's plant, distribution center or on site of the vending machine to thereby allow the maintenance person to easily adjust the mix of product to accommodate the perceived desires of the customers that use that particular vending machine.

It is yet another object of the present invention to provide for the easy disassembly of the snack from the beverage without special tools or other than ordinary strength on the part of the consumer while preserving the eye appeal of both the snack and beverage and the information presented on the promotional material.

It is yet another object of the present invention to provide a method of combining the snack and beverage that may be disengaged even if the cool beverage container causes the consumer's hands to become moist.

It is yet another object of the present invention to provide for the incorporation of promotional material in the combining of the snack and beverage without interference with the assembly and disassembly of the combination or the insertion of the combination into the preexisting vending machine rack space.

It is yet another object of the present invention to provide a method of assembly of the snack and beverage combination along with promotional material that will not become separated upon the insertion of the combination into the rack space nor become separated upon the normal vending travel of the combination from the rack along the dispensing pathway to the dispensing bin of the vending machine upon the condition of the consumer submitting payment and selecting a product.

Most vending machines have a product storage area segmented into racks with a series of shelves holding a product until a user inserts sufficient currency and selects a product. The next available shelf holding the selected product is activated to release the product to fall into the user accessible bin area. The user then removes the product from the accessible bin area and the vending machine is available to be used again unless all products within the product storage area have been dispensed.

A vending maintenance person periodically visits the site of the vending machine to remove the accumulated money, inspect the operation of the vending machine and to refill product into the product storage area.

Prior to the teaching of this invention, the racks of a vending machine were filled with a beverage container alone or a snack alone. Some prior art taught packaging snacks in containers the size of beverage containers or placing other products within containers the size of beverage cans/bottles to be dispensed by a beverage vending machine.

The vending machine maintenance person may fill the racks of the vending machine with a combined snack and beverage assembled according to the teaching of this invention. The combined snack and beverage may be preassembled at the beverage-manufacturing site or at a distribution center. The combination package may also be assembled by the vending machine maintenance person at the site of the vending machine to provide the flexibility of refilling the racks within the product storage area with a product mix in demand at that location as the preferences of the users of that vending machine change as perceived by the maintenance person after visiting the site and reviewing the sales information either recorded by the machine or visible by what was in the machine product storage area and what product is still remaining in the storage area. Because there are a limited number of items comprising this invention, the items are designed to be easily assembled into a preselected combination responsive to the changing preferences of the purchasing public. The assembly of the combination is maintained during the dispensing mode to prevent separation but is easily separated by the purchaser after removal from the dispensing bin of the vending machine.

The above and other objects of the present invention are achieved, according to a preferred enbodiment thereof, by providing an improved attachment of the snack to the beverage.

The snack may be a standard bag of peanuts or a preselected number of bags configured in a circle to surround the neck of the beverage. The ends of the bags are secured together during the manufacturing process to form a stable configuration which will not spilt and fall off the neck of the bottle once placed over the cap of the bottle and retained in place from slipping back over the top of the bottle.

Other preselected snacks may be prepackaged in a geometrically designed package such as a ringed bag or tube or a preselected number of triangular or pyramid shaped containers that may be wrapped around with the ends sealed so that the prepackaged snack will easily fit over the neck of the beverage container.

In the preferred enbodiment, assembly of a preformed snack package to a beverage container is accomplished by the application of a retaining device or containment cage attachable to a beverage bottle having a snack package-retaining portion and a beverage bottle cap disengagable engagement portion. The engagement portion may incorporate a plurality of flexible fingers that fit under the lower edge of the cap or under the ring just below the bottom of the cap. The attachment portion may also incorporate a plurality of ribs that engage the outside surface of the cap. The purpose of the attachment device is to secure the snack to the beverage so that it will not slip off the beverage bottle top. The attachment device should accomplish this function without requiring any special clips or tools to attach the device to the beverage bottle cap or snack. The outer edge of the attachment device could be formed into a ridge to further assist in retaining the snack in place on the beverage bottle.

### BRIEF DESCRIPTION OF THE DRAWINGS

The above and other embodiments of the present invention may be more fully understood from the following detailed description, taken together with the accompanying drawings, wherein similar reference characters refer to similar elements throughout, and in which:

FIG. 1 is a perspective view of the assembled snack and beverage bottle according the invention;

FIG. 2 is a perspective view of the disassembled combination;

FIG. 3 is a perspective view of the retaining device;

FIG. 4 is a perspective view of another embodiment of the assembled snack and beverage bottle according to the invention with optional promotional material;

FIG. 5 is a perspective view of the combination according the other embodiment with the top open;

FIG. 6 is a perspective view of the combination according to the other embodiment illustrated disassembled with the optional promotional material and snack removed;

FIG. 7 is a perspective view of the containment cage used in the other embodiment;

FIG. 8 is a perspective view of the optional promotional material in the form of a mini-CD;

FIG. 9 is a perspective view of another embodiment of the retainer and beverage cap attachment with extended fingers; and,

FIG. 10 is a perspective view of the beverage cap attachment with internal rings.

### DESCRIPTION OF A PREFERRED EMBODIMENT

The overall function of the invention herein is best understood from FIG. 1. The combined snack and beverage 101 is assembled by placing a configured snack 103 over the neck 113 of the beverage 102 and securing the snack 103 to the beverage 102 with a retaining device 104. The retaining device 104 illustrated in FIG. 3 is fabricated of a limiting disk 105 and a beverage cap attachment 106 centrally mounted to one side of said limiting disk 105.

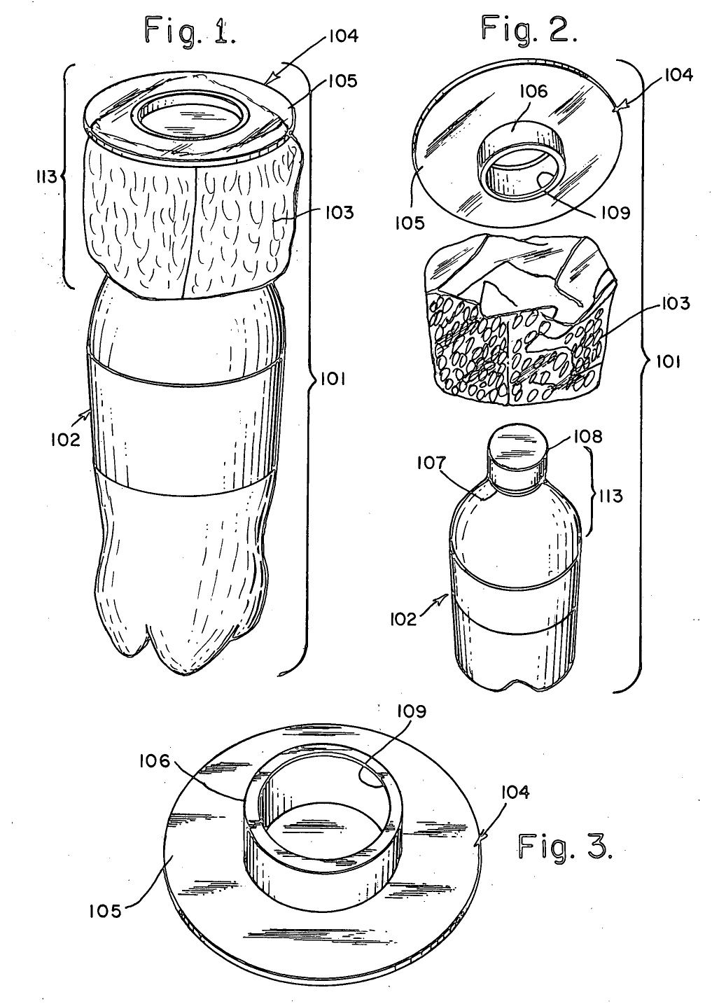

FIG. 2 illustrates the combination of FIG. 1 disassembled showing the beverage bottle 102 with a cap 108 sealing the beverage bottle. The cap 108 is tightened onto the beverage bottle 102 so that it is positioned adjacent the beverage bottle packaging ring 107. This packaging ring 107 is used by the manufacturer to prepackage a preselected number of beverages into a convenient carrying package by applying a plastic carrier under the packaging ring so as to assemble a six pack of beverage bottles 102 much as beverage cans are assembled into a six pack with the convenient six ringed packaging device slipped over the top rim of the containers.

FIG. 3 illustrates the retaining device 104 as fabricated of a limiting disk 105 and a beverage cap attachment 106 mounted to the center of one side of the limiting disk 105 whereby upon engagement of the beverage cap attachment 106 with the cap 108, the limiting disk 105 is positioned to prevent the configured snack 103 from disengagement over the top of the beverage 102 until the beverage cap attachment 106 is disengaged from the cap 108. The ends of the configured snack 103 are attached to each other so as to prevent the ends from separating and allowing the snack to fall off the neck 113 of the beverage 102 especially during the dispensing process of the vending machine or the handling in an over-the-counter sale of the combined product.

The internal surface 109 of the beverage cap attachment 106 is fabricated of pliable material of a size to snugly fit over the cap 108 that usually incorporates a plurality of raised ridges to assist the user in obtaining a grip on the cap 108 to remove the cap 108 from the beverage 102. Therefore, the internal surface 109 usually adheres easily to the cap 108. For those beverages 102 that do not utilize a cap 108 that incorporates such ridges FIG. 9 illustrates a beverage cap attachment 106a additionally fabricated with a plurality of flexible extensions 110 mounted on the end of the beverage cap attachment 106a remote from the end of the beverage cap attachment 106a mounted to the limiting disk 105, the flexible extensions 110 are of a preselected length and shape whereby said extensions disengagibly engage the packaging ring 107 or the bottom edge of the cap 108 adjacent the packaging ring 107. FIG. 9 also illustrates the addition of a rim 112 extending from the circumferential edge of the limiting disk 105 in the same direction as the beverage cap attachment 106a to assist in retaining the configured snack 103 in its position on the neck 113 of the beverage 102. FIG. 9 further illustrates the application of promotional material 401 in the form of advertising to the limiting disk 105.

FIG. 10 illustrates another embodiment of the retaining device 104a wherein the internal surface 109 of the beverage cap attachment 106 further includes a plurality of rings 111 mounted on the internal surface 109 and extending perpendicular to the internal surface 109 whereby, upon engagement of the internal surface 109 with the cap 108 the rings 111 disengagibly engage the cap 108 thereby holding the retaining device 104 in place.

The assembled combination of snack and beverage may also contain optional promotional material. This optional promotional material may consist of coupons, a mini-CD or other items used to form the limiting disk 105 of the retaining device 104. The mini-CD may be preprogrammed with a sample of software, software that prints coupons, a sample track from a full size audio disk, a movie clip or promotional material of a music group or movie featuring the beverage or snack product or sponsored by the beverage or snack manufacturing company. This additional promotional material may be very useful in advertising after market items and further promote purchases of the selected product and thus is further enticement for the consumer to make a purchase at a vending machine equipped with the combination of snack, beverage and optional promotional material. Care must be taking in attachment of the optional promotional material to the beverage cap attachment 106 so as to not damage the promotional material or prevent the promotional material from being detached from the beverage cap attachment 106 in a damaged or unusable condition.

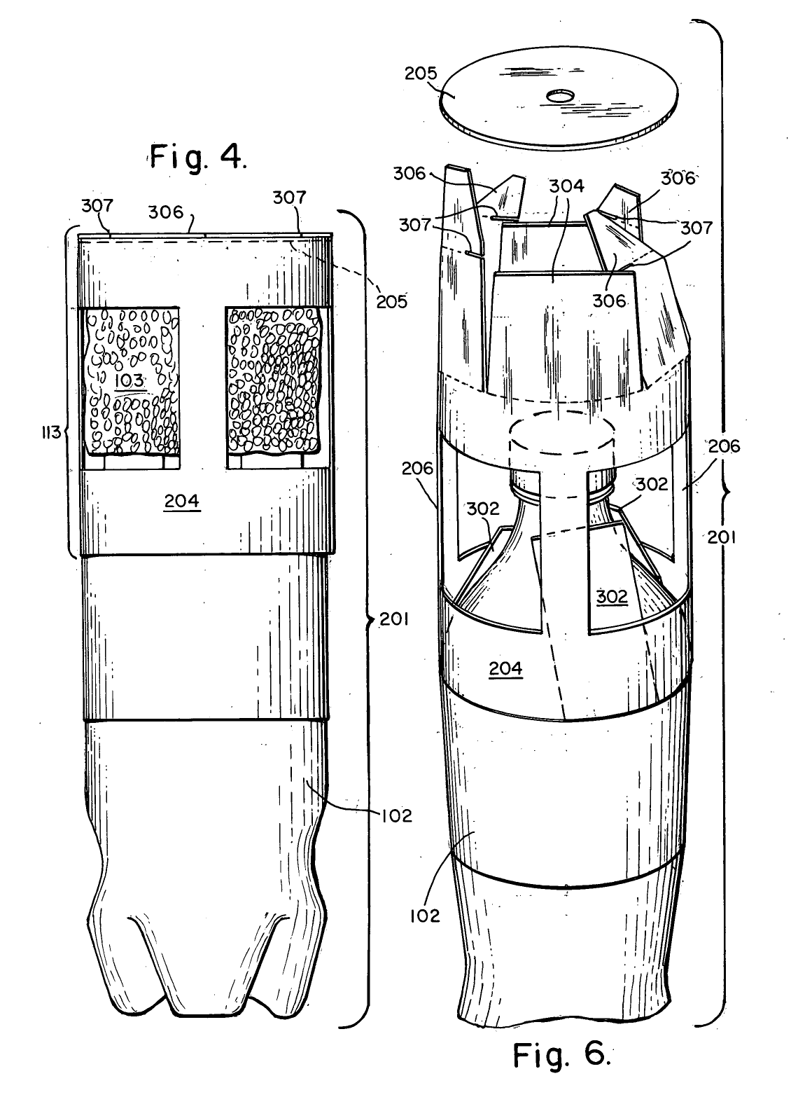

Another embodiment of the arrangement is illustrated in FIG. 4 and generally designated 201. The beverage 102 and snack 103 are assembled into the combination by use of a containment cage 204.

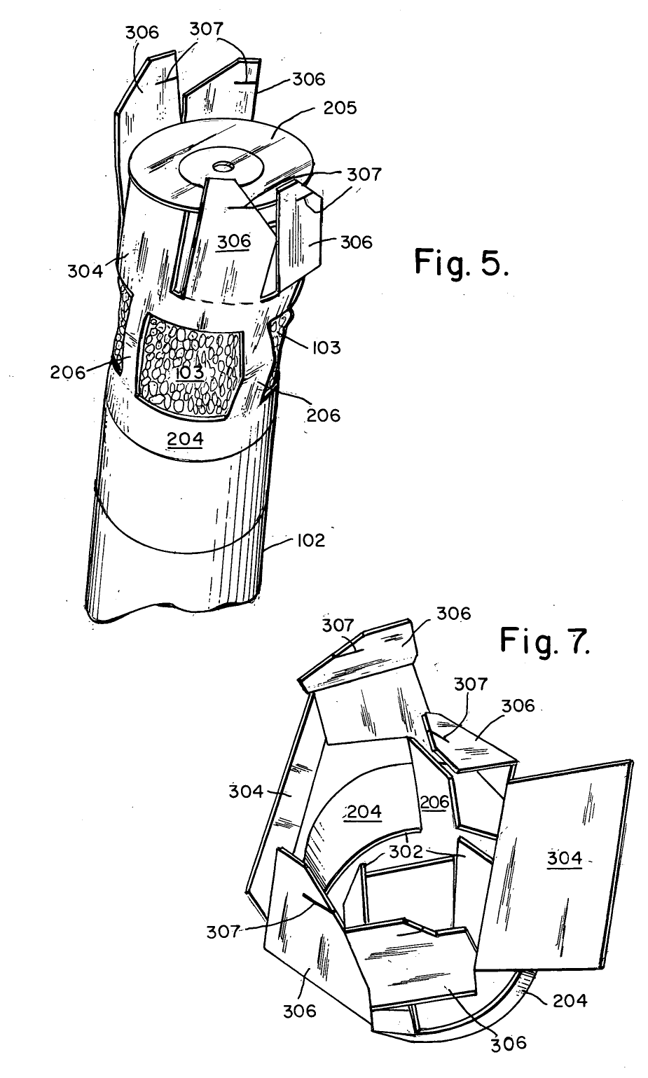

FIG. 5 illustrates the embodiment of FIG. 4 with the top of the containment cage 204 open exposing the optional promotional material 205 that is in the form of a mini CD. FIG. 6 illustrates the optional promotional material 205 removed and ready to use.

FIG. 7 illustrates the containment cage 204 that is fabricated in a cylindrical shape of foldable sheet material and includes a plurality of fingers 302 folded upward from the base of the containment cage 204. Said fingers 302 are fabricated of a length to be positioned along the outside neck 113 of the beverage bottle 102 and engage the bottom of the packaging ring 107 under the bottle cap 108 of the beverage 102 under the condition of the containment cage 204 being placed over the cap 108 of the beverage 102. The containment cage 204 is fabricated with a plurality of separation strips 206 spaced apart to display the configured snack 103 upon the condition of the snack inserted within the containment cage 204. The separation strips 206 are of a length to extend from the base of the cage 204 to the top of the cap of the beverage 102.

The containment cage 204 is positioned over the neck of the beverage bottle 102 so that the plurality of fingers 302 extend from the folds attaching the fingers 302 to the base of the containment cage 204 upwards towards the cap 108. The configured snack 103 is inserted over the cap 108 of the beverage bottle 102 in a position to be within the containment cage 204 thereby holding the plurality of fingers 302 against the outside surface of the beverage 102 in position along the neck 113, the upper edges of the fingers 302 positioned under the packaging ring 107 thereby preventing the containment cage 204 from disengaging from the beverage 102.

The top of the containment cage 204 is fabricated with opposing folding platforms 304. Upon the condition of the opposing folding platforms folded on top of the cap 108, the optional promotional material 205 may be mounted on top of the folded platforms 304 and held in place with a plurality of folding extensions 306 folded over the optional promotional material 205. Two opposing folding extensions 306 are fabricated with a slot 307. These two extensions 306 are folded last and the slots 307 engaged with each other to hold the containment cage 204 in a fully assembled and closed condition around the optional promotional material 401 thereby holding the optional promotional material 401 with out damage and allowing the optional promotional material 401 to be easily removed from the combination for use by the simple step of disengaging the slots 307 and unfolding the extensions 306.

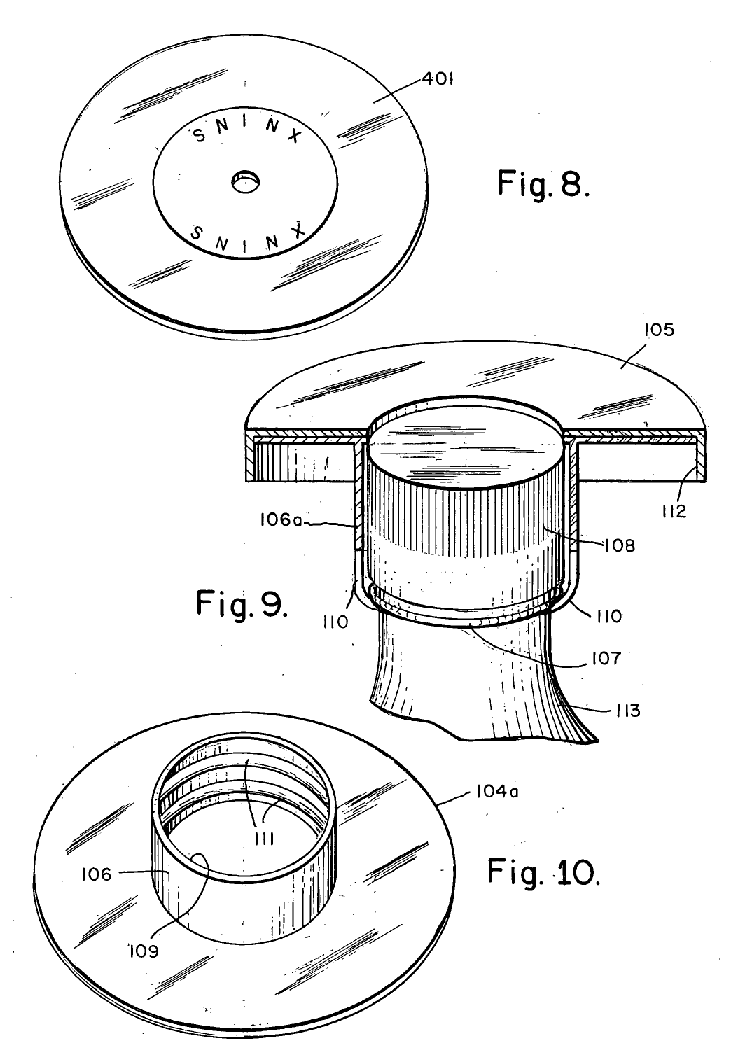

FIG. 8 illustrates the optional promotional material 401 as a mini CD the outside surface of which is imprinted with further promotional material or have a peal off coupon for additional purchase of one of the combined products attached to the non-optical surface.

The combined snack and beverage 101 may be preassembled by the beverage bottler by the process of having the empty beverage 102 with configured snack 103 mounted on the neck 113 filled at the beverage bottler plant and thereafter capping the beverage 102 with a retaining device 104 comprised of the beverage cap 108 fabricated with a limiting disk 105 after the empty beverage bottle 102 is filled. This preassembled combination should preselect the most popular beverage and snack combination based upon the history of sales in the vending machines to be services so that the preassembled combination can be transported to the vending machine site and immediately loaded into empty storage rack compartments. This preassembled combination of snack and beverage may also be utilized for off-the-shelf sales.

However, as consumer preferences change as reflected by analysis of sales at each individual vending machine sites, this preassembled combination may be augmented or replaced with manually assembled beverage and snack combinations at the vending machine site during the maintenance operation.

Since certain change may be made in the above apparatus without departing from the scope of the invention herein involved, it is intended that all matter contained in the above description, as illustrated in the accompanying drawing, shall be interpreted in an illustrative, and not a limiting sense.

1. A process for assembly of a combination of a beverage container having a cap and a snack food product preconfigured to be mounted over said cap and dispensing said combination from a pre-existing vending machine having an internal product storage area configured with individually selectively releasable product storage rack compartments in communication with a consumer accessible area of said vending machine, whereby said beverage and mounted configured snack combination is mounted within one of said releasable product storage rack compartments thereby occupying the same space within said compartment as a single product container alone and poised to be dispensed from said internal product storage area of said vending machine, the process comprising the steps of:
transporting filled and capped beverage containers and preconfigured snack products to the site of said vending machine for the purpose of performing the maintenance function of said vending machine; and,
performance of said maintenance function including the replenishment of said vending machine internal storage rack compartments with said combination of beverage and configured snack assembled as a unit;
replenishment comprising the steps of;
selection of said filled beverage container and said preconfigured snack based upon prior sales history of said vending machine;
assembling said snack and said beverage as a unit with a retaining device and inserting said unit into an empty product storage rack compartment; and,
setting the price point for said product storage rack compartment, the contents to be dispensed from said product storage rack compartment to said consumer accessible area for pickup by the consumer upon the condition of the consumer inserting sufficient currency into said vending machine as established by said set price point and entering a selection of the contents of said product storage rack compartment thereby releasing and dispensing into said consumer accessible area said selected stored unit of a combined beverage container and snack food container thereafter said beverage and snack being easily removed from said consumer accessible area as a unit and thereafter separated by said consumer for consumption of said beverage and said snack.

2. A process for assembly of a combination of a beverage container having a packaging ring and a cap tightened above said packaging ring and a snack food product preconfigured to be mounted over said cap and said packaging ring and dispensing said combination from a pre-existing vending machine having an internal product storage area configured with individually selectively releasable product storage rack compartments in communication with a consumer accessible area of said vending machine, whereby said beverage and mounted configured snack combination is mounted within one of said releasable product storage rack compartments thereby occupying the same space within said compartment as a single product container alone and poised to be dispensed from said internal product storage area of said vending machine, the process comprising the steps of:
transporting filled and capped beverage containers and preconfigured snack products to the site of said vending machine for the purpose of performing the maintenance function of said vending machine; and,
performance of said maintenance function including the replenishment of said vending machine internal storage rack compartments with said combination of beverage and configured snack assembled as a unit;
replenishment comprising the steps of;
selection of said filled beverage container and said preconfigured snack based upon prior sales history of said vending machine;
assembling said snack and said beverage as a unit with a retaining device and inserting said unit into an empty product storage rack compartment; and,
setting the price point for said product storage rack compartment, the contents to be dispensed from said product storage rack compartment to said consumer accessible area for pickup by the consumer upon the condition of the consumer inserting sufficient currency into said vending machine as established by said set price point and entering a selection of the contents of said product storage rack compartment thereby releasing and dispensing into said consumer accessible area said selected stored unit of a combined beverage container and snack food container thereafter said beverage and snack being easily removed from said consumer accessible area as a unit and thereafter separated by said consumer for consumption of said beverage and said snack.

3. The process according to claim 1 wherein said vending machine is a refrigerated beverage vending machine.

4. The process according to claim 1 wherein said vending machine is a refrigerated snack vending machine.

5. The process according to claim 2 wherein said vending machine is a refrigerated beverage vending machine.

6. The process according to claim 2 wherein said vending machine is a refrigerated snack vending machine.

7. The process according to claim 1 wherein said retaining device is fabricated of a limiting disk and a beverage cap attachment mounted to one side of said limiting disk whereby upon engagement of said beverage cap attachment with said cap, said limiting disk is positioned to prevent said preconfigured snack from disengagement over said cap of said beverage until said retaining device is detached from said beverage cap.

8. The process according to claim 7 wherein said beverage cap attachment further comprises a plurality of retaining rings mounted inside said beverage cap attachment and disengably engageable with the outside of said beverage cap.

9. The process according to claim 7 wherein said beverage cap attachment further comprises a plurality of flexible inwardly curving fingers extending from the edge of said beverage cap attachment remote from said limiting disk whereby upon engagement of said beverage cap attachment with said beverage cap, said fingers engage said packaging ring.

10. The process according to claim 2 wherein said retaining device is fabricated of a limiting disk and a beverage cap attachment mounted to one side of said limiting disk whereby upon engagement of said beverage cap attachment with said cap, said limiting disk is positioned to prevent said preconfigured snack from disengagement over said cap and packaging ring of said beverage until said retaining device is detached from said beverage cap.

11. The process according to claim 10 wherein said beverage cap attachment further comprises a plurality of fingers extending from the end of said beverage cap attachment remote from said limiting disk and disengagibly engageble with said packaging ring.

12. The process according to claim 10 wherein said beverage cap attachment further comprises a plurality of flexible inwardly curving fingers extending from the edge of said beverage cap attachment remote from said limiting disk whereby upon engagement of said beverage cap attachment with said beverage cap, said fingers engage said packaging ring.

13. A process for assembly of a combination of a beverage container having a cap and a snack food product preconfigured to be mounted over said cap and dispensing said combination from a pre-existing vending machine having an internal product storage area configured with individually selectively releasable product storage rack compartments in communication with a consumer accessible area of said vending machine, whereby said beverage and mounted configured snack combination is mounted within one of said releasable product storage rack compartments thereby occupying the same space within said compartment as a single product container alone and poised to be dispensed from said internal product storage area of said vending machine, the process comprising the steps of:
transporting filled and caped beverage containers and preconfigured snack products to the site of said vending machine for the purpose of performing the maintenance function of said vending machine; and,
performance of said maintenance function including the replenishment of said vending machine internal storage rack compartments with said combination of beverage and configured snack assembled as a unit;
replenishment comprising the steps of;
selection of said filled beverage container and said preconfigured snack based upon prior sales history of said vending machine;
assembling said snack and said beverage as a unit with a containment cage and inserting said unit into an empty product storage rack compartment; and,
setting the price point for said product storage rack compartment, the contents to be dispensed from said product storage rack compartment to said consumer accessible area for pickup by the consumer upon the condition of the consumer inserting sufficient currency into said vending machine as established by said set price point and entering a selection of the contents of said product storage rack compartment thereby releasing and dispensing into said consumer accessible area said selected stored unit of a combined beverage container and snack food container thereafter said beverage and snack being easily removed from said consumer accessible area as a unit and thereafter separated by said consumer for consumption of said beverage and said snack.

14. A process for assembly of a combination of a beverage container having a packaging ring and a cap tightened above said packaging ring and a snack food product preconfigured to be mounted over said cap and said packaging ring and dispensing said combination from a pre-existing vending machine having an internal product storage area configured with individually selectively releasable product storage rack compartments in communication with a consumer accessible area of said vending machine, whereby said beverage and mounted configured snack combination is mounted within one of said releasable product storage rack compartments thereby occupying the same space within said compartment as a single product container alone and poised to be dispensed from said internal product storage area of said vending machine, the process comprising the steps of:
transporting filled and caped beverage containers and preconfigured snack products to the site of said vending machine for the purpose of performing the maintenance function of said vending machine; and,
performance of said maintenance function including the replenishment of said vending machine internal storage rack compartments with said combination of beverage and configured snack assembled as a unit;
replenishment comprising the steps of;
selection of said filled beverage container and said preconfigured snack based upon prior sales history of said vending machine;
assembling said snack and said beverage as a unit with a containment cage and inserting said unit into an empty product storage rack compartment; and.
setting the price point for said product storage rack compartment, the contents to be dispensed from said product storage rack compartment to said consumer accessible area for pickup by the consumer upon the condition of the consumer inserting sufficient currency into said vending machine as established by said set price point and entering a selection of the contents of said product storage rack compartment thereby releasing and dispensing into said consumer accessible area said selected stored unit of a combined beverage container and snack food container thereafter said beverage and snack being easily removed from said consumer accessible area as a unit and thereafter separated by said consumer for consumption of said beverage and said snack.

15. The process according to claim 13 wherein said containment cage device is fabricated of foldable sheet material as a cylindrical shaped cage having a base further comprising:
a plurality of separating strips spaced apart and extending from said base to the cap of the beverage to display said configured snack package; and,
a plurality of fingers extending upward from said base and folded to lie along the neck of said beverage, said fingers of a size to extend from said base and be in contact with said packaging ring;
whereby under the condition of said configured snack package inserted within said cage and said cage installed on the neck of said beverage said configured snack holds said fingers along the outside of said beverage container and the ends of said fingers are positioned under said packaging ring to prevent said cage from disengaging from said beverage container.

16. The process according to claim 14 wherein said containment cage device is fabricated of foldable sheet material as a cylindrical shaped cage having a base further comprising:
a plurality of separating strips spaced apart and extending from said base to the cap of the beverage to display said configured snack package; and,
a plurality of fingers extending upward from said base and folded to lay along the neck of said beverage, said fingers of a size to extend from said base and be in contact with said packaging ring; whereby under the condition of said configured snack package inserted within said cage and said cage installed on the neck of said beverage said configured snack holds said fingers along the outside of said beverage container and the ends of said fingers are positioned under said packaging ring to prevent said cage from disengaging from said beverage container.

17. The process according to claim 15 said containment cage device further comprising:
a plurality of folding platforms attached to said separating extensions remote from said base in a position to be foldable over the top of the cap of said beverage;
a plurality of folding extensions of said separating strips the ends of said folding extensions having engageble slots;
whereby said platform may be folder over the top of said cap and thereafter said extensions folder over said platform, at least one opposing pair of folding extensions being engageble in a closing position over said platform by engaging of said slots.

18. The process according to claim 16 said containment cage device further comprising:
a plurality of folding platforms attached to said separating extensions remote from said base in a position to be foldable over the top of the cap of said beverage;
a plurality of folding extensions of said separating strips the ends of said folding extensions having engageble slots;
whereby said platform may be folder over the top of said cap and thereafter said extensions folder over said platform, at least one opposing pair of folding extensions being engageble in a closing position over said platform by engaging of said slots.

19. The process according to claim 17 wherein preselected optional promotional material is mounted on said containment cage platform and held on said platform by engagement of said opposing extensions.

20. The process according to claim 18 wherein preselected optional promotional material is mounted on said containment cage platform and held on said platform by engagement of said opposing extensions.

21. The process according to claim 11 wherein said vending machine is a refrigerated beverage vending machine.

22. The process according to claim 11 wherein said vending machine is a refrigerated snack vending machine.

23. The process according to claim 12 wherein said vending machine is a refrigerated beverage vending machine.

24. The process according to claim 12 wherein said vending machine is a refrigerated snack vending machine.

25. The process of pre-assembly of a combination of a beverage container having a cap and a snack food product preconfigured to be mounted over said cap as a unit whereby said beverage container and mounted configured snack combination occupies essentially the same shelf foot-print space as the beverage container alone and delivery of said unit to a point of sale, the process comprising the steps of:
selection of said beverage container and preconfigured snack based upon the prior sales history of said point of sale;
pre-assembling said beverage and said preconfigured snack as a unit by means of a retaining device;
transporting said pre-assembled units to said point of sale; additionally transporting filled and capped beverage containers and preconfigured snack products to said point of sale and performing the restocking of said point of sale;
performance of said restocking including the delivery of the pre-assembled units and augmenting said restocking with assembling said preconfigured snack and said beverage container as a unit by means of a retainer device based upon the sales history and current inventory held at said point of sale.

26. The process according to claim 25 wherein said augmenting said restocking with the preassembled includes the steps of:
selection of said filled beverage container and said preconfigured snack based upon prior sales;
assembling said snack and said beverage as a unit with a retaining device fabricated of a limiting disk and a beverage cap attachment mounted to one side of said limiting disk whereby upon engagement of said beverage cap attachment with said cap, said limiting disk is positioned to prevent said preconfigured snack from disengagement over said cap of said beverage until said retaining device is detached from said beverage cap; and,
delivery of said assembled units to said off the shelf point of sale.

27. The process according to claim 26 wherein said beverage cap attachment further comprises a plurality of retaining rings mounted inside said beverage cap attachment and disengably engageable with the outside of said beverage cap.

28. The process according to claim 26 wherein said beverage cap attachment further comprises a plurality of flexible inwardly curving fingers extending from the edge of said beverage cap attachment remote from said limiting disk whereby upon engagement of said beverage cap attachment with said beverage cap, said fingers engage said cap.

29. The process according to claim 25 wherein said preassembly of said snack and beverage as a unit is be means of a containment cage fabricated of foldable sheet material as a cylindrical shaped cage having a base further comprising:
a plurality of separating strips spaced apart and extending from said base to the cap of the beverage to display said configured snack package; and,
a plurality of fingers extending upward from said base and folded to lie along the neck of said beverage, said fingers of a size to extend from said base and be in contact with said packaging ring;
whereby under the condition of said configured snack package inserted within said cage and said cage installed on the neck of said beverage said configured snack holds said fingers along the outside of said beverage container and the ends of said fingers are positioned under said packaging ring to prevent said cage from disengaging from said beverage container.

30. The process according to claim 29 said containment cage further comprising:
a plurality of folding platforms attached to said separating extensions remote from said base in a position to be foldable over the top of the cap of said beverage;
a plurality of folding extensions of said separating strips the ends of said folding extensions having engageble slots;
whereby said platform may be folder over the top of said cap and thereafter said extensions folder over said platform, at least one opposing pair of folding extensions being engageble in a closing position over said platform by engaging of said slots.

31. The process according to claim 30 wherein preselected optional promotional material is mounted on said containment cage platform and held on said platform by engagement of said opposing extensions.

32. A process for assembly of a combination of a beverage container having a cap and a snack food product preconfigured to be mounted over said cap and dispensing said combination in place of a single product such as from a pre-existing vending machine having an internal product storage area configured with individually selectively releasable product storage rack compartments in communication with a consumer accessible area of said vending machine, whereby said beverage and mounted configured snack combination is mounted within one of said releasable product storage rack compartments thereby occupying the same space within said compartment as a single product container alone and poised to be dispensed from said internal product storage area of said vending machine, and off-the shelf sales, the process comprising the steps of:
transporting filled and capped beverage containers and preconfigured snack products to the site of said sales and vending machine for the purpose of performing the maintenance function of said off-the shelf sales and vending machine sales; and,
performance of said maintenance function including the replenishment of inventory of said sales site shelf and vending machine internal storage rack compartments with said combination of beverage and configured snack assembled as a unit;
replenishment comprising the steps of;
selection of said filled beverage container and said preconfigured snack based upon prior sales history of said sales site shelf and vending machine;
assembling said snack and said beverage as a unit with a retaining device and inserting said unit into an empty shelf space including said product storage rack compartment; and,
setting the price point for said product storage rack compartment, the contents to be sold off the shelf including being dispensed from said product storage rack compartment to said consumer accessible area for pickup by the consumer upon the condition of the consumer tendering or inserting sufficient currency into said vending machine as established by said set price point and entering a selection of the contents of said product storage rack compartment thereby releasing and dispensing into said consumer accessible area said selected stored unit of a combined beverage container and snack food container thereafter said beverage and snack being easily removed from said consumer accessible area as a unit and thereafter separated by said consumer for consumption of said beverage and said snack.
